(19) United States
(12) Patent Application Publication
(10) Pub. No.: US 2009/0114620 A1
(43) Pub. Date: May 7, 2009

(54) ATOM PROBE ELECTRODE TREATMENTS

(75) Inventors: Robert M. Ulfig, Middleton, WI (US); Joseph H. Bunton, Madison, WI (US); Thomas F. Kelly, Madison, WI (US); David J. Larson, Madison, WI (US); Richard L. Martens, Madison, WI (US); Keith J. Thompson, Fitchburg, WI (US); Scott A. Wiener, Mount Horeb, WI (US)

Correspondence Address: PERKINS COIE LLP;PATENT-SEA, P.O. BOX 1247, SEATTLE, WA, 98111-1247, US

(73) Assignee: Imago Scientific Instruments Corporation, Madison, WI (US)

(21) Appl. No.: 11/917,685

(22) PCT Filed: Jul. 21, 2005
(86) PCT No.: PCT/US2005/025740

§ 371 Date: Jul. 21, 2008

Related U.S. Application Data
(60) Provisional application No. 60/690,997, filed on Jun. 16, 2005.

(51) Int. Cl. B44C 1/22; B05D 5/12

(52) U.S. Cl. 216/66; 216/83; 216/67; 427/58; 427/523

(57) ABSTRACT

A method for treating an atom probe electrode (120), which comprises the steps of providing an atom electrode (120) having a surface (123) and an aperture (122); and removing material (604) from the surface (123) to reduce a potential of the atom probe electrode creating a non-uniformity in an electric field (502) when the atom probe electrode is used in a atom probe device during specimen analysis.

### CROSS-REFERENCE TO RELATED APPLICATION(S)

This application claims the benefit of U.S. Provisional Patent Application No. 60/690,997 filed on Jun. 16, 2005, Entitled ATOM PROBE ELECTRODE TREATMENTS.

### TECHNICAL FIELD

Embodiments of the present invention relate to treatments for atom probe electrodes, including treatments for atom probe electrodes used in atom probe devices (e.g., atom probe microscopes).

### BACKGROUND

An atom probe (e.g., atom probe microscope) is a device which allows specimens to be analyzed on an atomic level. For example, a typical atom probe includes a specimen mount, an electrode, and a detector. During analysis, a specimen is carried by the specimen mount and a positive electrical charge (e.g., a baseline voltage) is applied to the specimen. The detector is spaced apart from the specimen and is negatively charged. The electrode is located between the specimen and the detector, and is either grounded or negatively charged. A positive electrical pulse (above the baseline voltage) and/or a laser pulse is intermittently applied to the specimen. With each pulse, one or more atom(s) on the specimen surface is ionized. The ionized atom(s) separate or “evaporate” from the surface, pass though an aperture in the electrode, and impact the surface of the detector. The identity of an ionized atom can be determined by measuring its time of flight between the surface of the specimen and the detector, which varies based on the mass/charge ratio of the ionized atom. The location of the ionized atom on the surface of the specimen can be determined by measuring the location of the atom's impact on the detector. Accordingly, as the specimen is evaporated, a three-dimensional map of the specimen's constituents can be constructed.

A problem with current atom probes is that irregularities associated with the electrodes can distort the electrical fields created by the electrical charges that are applied during analysis of a specimen. This distortion can interfere with the operation of the atom probe. For example, field distortion can cause electrode field emission where the electric field causes the electrode to emit one or more electrons and/or ions. These emissions can cause reduced data quality because the emissions can show up as “noise” on the detector. Additionally, these emissions can damage the electrode and/or damage the specimen by removing material from the electrode, removing material from the specimen, and/or transferring material between the electrode and the specimen. Damage to the electrode and/or the specimen can further reduce data quality and/or prevent operation of the atom probe.

### BRIEF DESCRIPTION OF THE DRAWINGS

FIG. 1 is a partially schematic illustration of an atom probe device that includes an atom probe assembly with an atom probe electrode in accordance with embodiments of the invention.

FIG. 2 is an enlarged isometric illustration of the atom probe electrode shown in FIG. 1.

FIG. 3 is a partially schematic illustration of a portion of an atom probe electrode having surface irregularities and electric field non-uniformities.

FIG. 4 is a partially schematic illustration of the portion of the atom probe electrode shown in FIG. 3, after being treated to reduce electric field non-uniformities with one or more processes in accordance with embodiments of the invention.

FIG. 5 is a flow diagram illustrating a process for treating an atom probe electrode in accordance with embodiments of the invention.

FIG. 6 is a flow diagram illustrating a process for treating an atom probe electrode in accordance with other embodiments of the invention.

FIG. 7 is a partially schematic illustration of an atom probe electrode during a treatment process in accordance with embodiments of the invention.

FIG. 8 is a partially schematic cross-sectional view of an atom probe electrode being impacted by ionized gas atoms in accordance with other embodiments of the invention.

### DETAILED DESCRIPTION

The present invention relates to treatments for atom probe electrodes, including treatments for atom probe electrodes used in atom probe devices (e.g., atom probe microscopes). For example, certain embodiments are directed toward treating atom probe electrodes to reduce a potential of the atom probe electrode creating a non-uniformity in an electric field when the atom probe electrode is used in an atom probe device during specimen analysis. Other embodiments are directed at processes of treating an atom probe electrode to reduce a potential of the atom probe electrode creating a field emission or a thermionic emission when the atom probe electrode is used in an atom probe device during specimen analysis. Some of the treatments can include processes that make a surface of the atom probe electrode smoother and/or increase a consistency or uniformity of material on the surface of the atom probe electrode. For example, in certain embodiments the treating processes can include depositing material on a surface of the atom probe electrode, removing material from the surface, heating the surface, cooling the surface, impacting the surface with ionized gas atoms, and/or applying laser energy to the surface.

In the following description, numerous specific details are provided in order to give a thorough understanding of embodiments of the invention. One skilled in the relevant art will recognize, however, that the invention may be practiced without one or more of the specific details, or with other methods, components, materials, etc. In other instances, well known structures, materials, or operations are not shown or described in order to avoid obscuring aspects of the invention.

References throughout the specification to “one embodiment” or “an embodiment” means that a particular feature, structure, or characteristic described in connection with the embodiment is included in at least one embodiment of the present invention. Thus, the appearances of the phrase “in one embodiment” or “in an embodiment” in various places throughout the specification are not necessarily all referring to the same embodiment. Furthermore, the particular features, structures, or characteristics may be combined in any suitable manner in one or more embodiments.

Accordingly, various embodiments of the invention are described below. First the structure and operation of atom probe devices are discussed. Then, various treatment processes in accordance with embodiments of the invention are described.

### A. Atom Probe Devices

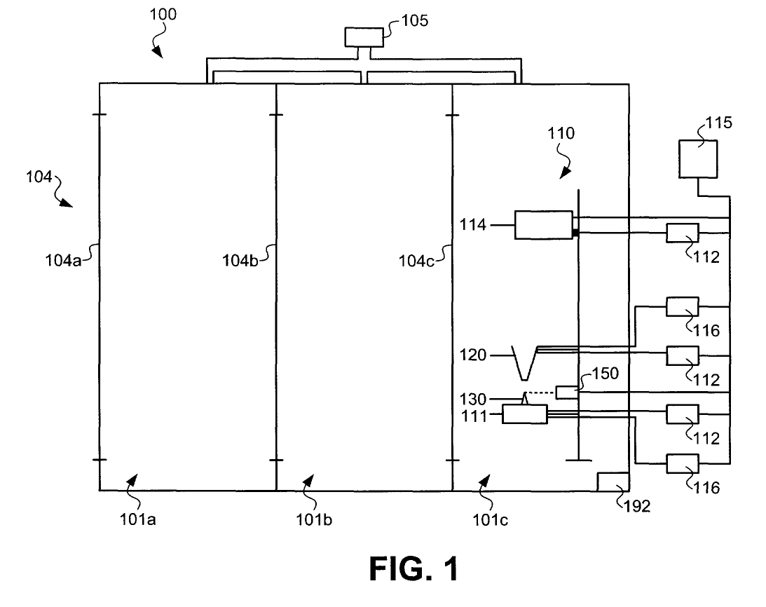

FIG. 1 is a partially schematic illustration of an atom probe device 100 in accordance with embodiments of the invention. In the illustrated embodiment, the atom probe device 100 includes a load lock chamber 101a, a buffer chamber 101b, and an analysis chamber 101c (shown collectively as chambers 101). The atom probe device 100 also includes a computer 115 and an atom probe assembly 110 having a specimen mount 111, an atom probe electrode 120, a detector 114, and an emitting device 150 configured to emit laser energy. The mount 111, electrode 120 and detector 114 can be operatively coupled to electrical sources 112. The electrode 120 and mount 111 can also be operatively coupled to temperature control devices 116 (e.g., cold/hot fingers that can provide contact cooling/heating to the atom probe electrode 120 and/or a specimen 130 carried by the mount 111). The emitting device 150, the detector 114, the voltage sources 112, and the temperature control devices 116 can be operatively coupled to the computer 115, which can control the analysis process and/or image display.

In the illustrated embodiment, each chamber 101 is operatively coupled to a fluid control system 105 (e.g., a vacuum pump and/or an ion pump) that is capable of lowering the pressure in the chambers 101 individually. Additionally, the atom probe device 100 can include sealable passageways 104 that allow items to be placed in, removed from, and/or transferred between the chambers 110. In the illustrated embodiment, a first passageway 104a is positioned between the interior of the load lock chamber 101a and the exterior of the atom probe device 100, a second passageway 104b is positioned between the interior of the load lock chamber 101a and the interior of the buffer chamber 101b, and a third passageway 104c is positioned between the interior of the buffer chamber 101b and the interior of the analysis chamber 101c. In certain embodiments, a transfer device (e.g., a mechanical arm) can be positioned to move items between the chambers 104 and/or place or remove items on/in the atom probe assembly 110.

In FIG. 1, a specimen can be placed in the load lock chamber 101a via the first passageway 104a. All of the passageways 104 can be sealed and the fluid control system 105 can lower the pressure in the load lock chamber 101a (e.g., reduce the pressure to 10⁻⁶-10⁻⁷ torr). The pressure in the buffer chamber 101b can be set at approximately the same or a lower pressure than the load lock chamber 101a. The second passageway 104b can be opened, the specimen 130 can be transferred to the buffer chamber 101b, and the second and third passageways 104b and 104c can be sealed.

The fluid control system 105 can then lower the pressure in the buffer chamber 101b (e.g., reduce the pressure to 10⁻⁸-10⁻⁹ torr). The pressure in the analysis chamber 101c can be set at approximately the same or a lower pressure than the buffer chamber 101b. The third passageway 104c can be opened, the specimen 130 can be transferred to the analysis chamber 101c, and the third passageway 104c can be sealed.

The fluid control system 105 can then reduce the pressure in the analysis chamber 101c (e.g., the pressure can be lowered to 10⁻¹⁰-10⁻¹¹ torr) prior to analysis of the specimen 130. In the illustrated embodiment, a getter 192 is positioned in the analysis chamber 101c to aid in lowering the pressure. In other embodiments, a getter 192 can be used in other chambers 101 or not used in the atom probe device. In still other embodiments, multiple items can be loaded or positioned in the chambers 101 of the atom probe device 100 using a similar method. For example, multiple specimens 130 can be positioned in the buffer chamber 101b and rotated through the analysis chamber 101c for analysis and/or multiple electrodes can be stored in the buffer chamber 101b and used to replace damaged electrodes in the analysis chamber 101c as required.

During analysis of the specimen 130, a positive electrical charge (e.g., a baseline voltage) can be applied to the specimen. The detector can be negatively charged and the electrode can be either grounded or negatively charged. A positive electrical pulse (above the baseline voltage) can be intermittently applied to the specimen 130 or a negative electrical pulse can be applied to the electrode 120. The electric field(s) created by the electrical charges can provide energy to ionize one or more atom(s) on the surface of the specimen 130. These ionized atom(s) can separate or “evaporate” from the surface, pass though an aperture in the electrode 120, and impact the surface of the detector 114. As the specimen 130 is evaporated, a three-dimensional map of the specimen's constituents can be constructed.

In certain embodiments, laser energy from the emitting device 150 can be used to thermally pulse a portion of the specimen 130 to assist with the evaporation process (e.g., the removal of ionized atoms). Additionally, in certain embodiments a temperature control device 116 can be used to cool the specimen 130 to reduce thermal motion and thermionic emission from the specimen. Thermionic emission includes the flow of one or more electrons from a metal or metal oxide surface, caused by thermal vibrational energy overcoming the electrostatic forces holding electrons to the surface. Thermionic emission from portions of the specimen 130 (or specimens in a multiple array) can reduce the accuracy of the analysis process.

In other embodiments, the atom probe device 100 can have more, fewer, and/or other arrangements of components. For example, in certain embodiments the atom probe device 100 can include more or fewer chambers, or no chambers. In other embodiments, the atom probe device can include multiple atom probe electrodes 120 and/or electrode(s) 120 having different configurations (e.g., planar electrode(s)). In still other embodiments, the atom probe device 100 includes more or fewer emitting devices 150, more or fewer temperature control systems 116, and more or fewer electrical sources 112.

During the analysis process, non-uniformities (e.g., distortions) in the electric field(s) can interfere with the operation of the atom probe. For example, distorted electrical field(s) can interfere with the orderly evaporation of the specimen 130 and/or cause electrode or specimen field emission, both of which can reduce data quality, damage the electrode 120, and/or damage the specimen 130. One cause of non-uniformities in the electric field(s) can be irregularities associated with the electrode 120.

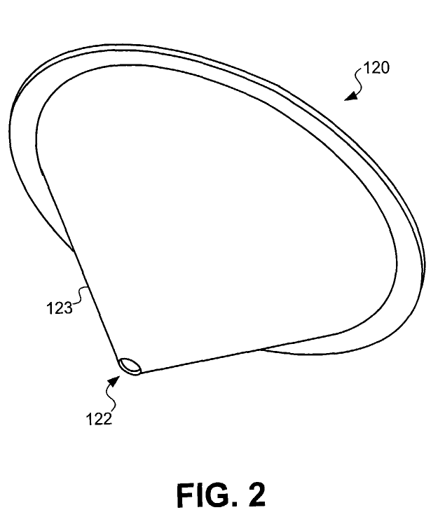

FIG. 2 is an enlarged isometric illustration of the atom probe electrode 120 shown in FIG. 1, where the electrode 120 has been removed from the atom probe assembly 110. In the illustrated embodiment, the electrode 120 has a conical shape and includes at least one surface 123 and an aperture 122 (e.g., an aperture 122 with a diameter of 5-100 microns). In other embodiments, the electrode 120 can have other configurations. For example, in certain embodiments the electrode 120 can be generally planar or consist of one or more conical shaped electrodes nested within each other.

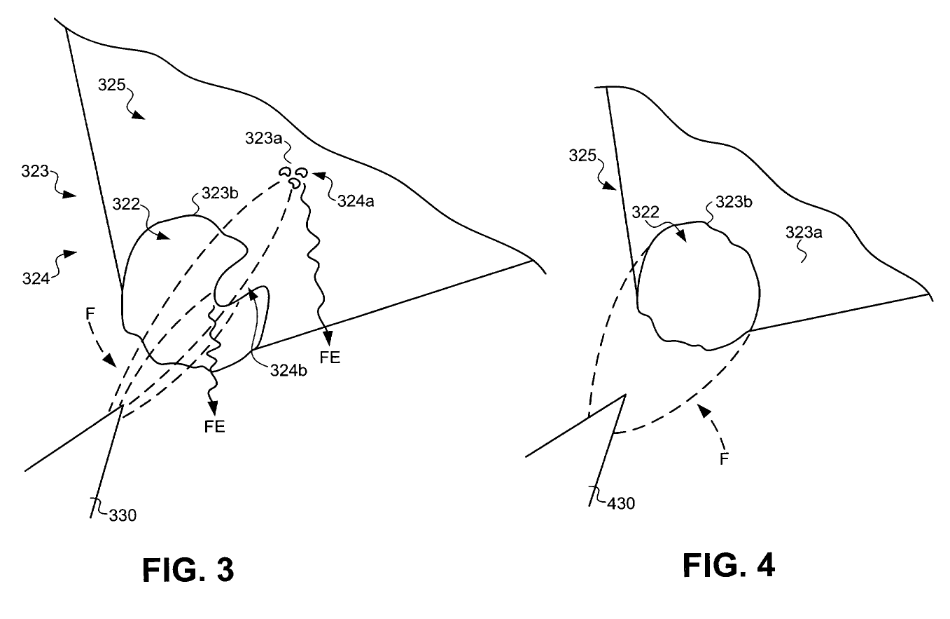

FIG. 3 is a partially schematic illustration of a portion of an atom probe electrode 325 proximate to a specimen 330. The portion of the electrode 325 includes at least one surface 323 and an aperture 322. In the illustrated embodiment, the portion of the electrode 325 includes at least two surfaces 323, shown as a first surface 323a and a second surface 323b that surrounds the aperture 322. In other embodiments, the atom probe electrode can have more or fewer surfaces 323. For example, in certain embodiments the atom probe electrode 325 can include multiple adjacent surfaces 323 (e.g., adjacent surfaces in the same plane with each surface having a different location and a different surface area).

In FIG. 3, the first and second surfaces 323a and 323b both include at least one irregularity 324. As used herein, irregularities can include inconsistencies or non-uniformities in the surface 323 that affect electric field(s) F proximate to the electrode, including protrusions or indentations on the surfaces 323 and/or inconsistency or non-uniformities of material(s) on/in the surface 323 (e.g., where the surface includes different materials, different crystalline structures, and/or different atomic structures that have different electrical characteristics). Irregularities can occur on the electrode 320 for various reasons, including structural or compositional defects created during the manufacturing process, damage sustained during specimen analysis, and environmental effects (e.g., oxidation).

In the illustrated embodiment, the first surface 323a includes a first irregularity 324a where the material is inconsistent with that of the surrounding area. This inconsistency in material can create portions on the first surface 323a that have differing work functions (e.g., where work function is the minimum amount of energy required to remove an electron from a material). Accordingly, this inconsistency in material can cause non-uniformities (e.g., asymmetries and/or areas of concentration) in the electric field(s) F proximate to the electrode and/or the specimen 330. In FIG. 3, the second surface 323b includes a second irregularity 324b where there is a protrusion extending into the aperture 322. This irregularity 324 can also cause non-uniformities in the electric field(s) F proximate to the electrode and/or the specimen 330. These non-uniformities can in turn, cause undesirable field emission FE.

FIG. 4 is a partially schematic illustration of the portion of the atom probe electrode 325 shown in FIG. 3, after being treated to reduce electric field non-uniformities with one or more processes in accordance with embodiments of the invention. In FIG. 4 the first and second surfaces 323a and 323b have been made smoother and/or the consistency or uniformity of the material in/on the surfaces 323 has been increased. Accordingly, the first and second irregularities 324a and 324b have been removed or modified so that the electric field(s) F proximate to the electrode and/or specimen 430 are more uniform (e.g., more symmetrical). The increase in uniformity of the electric field(s) F can reduce the potential for the undesirable field emission FE shown in FIG. 3. In other embodiments, a treatment process can remove more or fewer irregularities and/or have a larger or smaller affect on the potential for reducing field emission FE.

### B. Treatment Processes

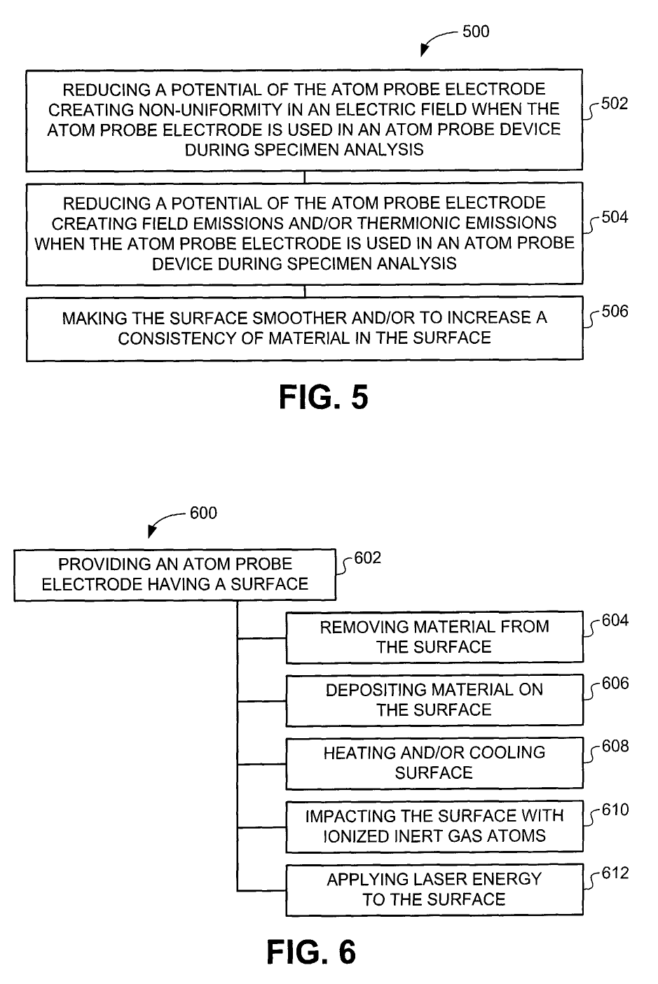

As discussed above and illustrated in FIG. 5, a treatment process 500 can include treating an atom probe electrode surface to: (a) reduce a potential of the atom probe electrode creating non-uniformity in an electric field when the atom probe electrode is used in an atom probe device during specimen analysis (Process Portion 502); (b) reduce a potential of the atom probe electrode creating field emission and/or thermionic emission when the atom probe electrode is used in an atom probe device during specimen analysis (Process Portion 504); and/or (c) make the surface smoother and/or to increase a consistency or uniformity of material in the surface (Process Portion 506). As shown in FIG. 6, in other embodiments the treatment process can include providing an atom probe electrode having a surface (Process Portion 602) and performing one or more additional process steps. For example, the process can further include (a) removing material from the surface (Process Portion 604), (b) depositing material on the surface (Process Portion 606), (c) heating and/or cooling the surface (Process Portion 608), (d) impacting the surface with ionized gas atoms (Process Portion 610), and/or (e) applying laser energy to the surface (Process Portion 612).

In certain embodiments, process portions discussed above can be accomplished on newly manufactured atom probe electrodes (e.g., used to treat newly formed probes and/or prepare the probes for use). In other embodiments, process portions discussed above can be used to refurbish or repair old and/or damaged electrodes. In various embodiments, process portions discussed above can be accomplished in a lab or in a controlled environment where various environmental characteristics (e.g., temperature, pressure, and the composition of the surrounding fluid) can be selected and/or controlled. Accordingly, certain process portions can be accomplished under selected environmental conditions (e.g., in a high or low pressure environment). In certain embodiments, process portions discussed above can also be accomplished in the atom probe device, with the electrode installed in or removed from the atom probe assembly. When process portions are accomplished in the atom probe device, in certain embodiments they can be accomplished in a low pressure environment (e.g., less than atmospheric pressure) and in other embodiments they can be accomplished at atmospheric pressure or above.

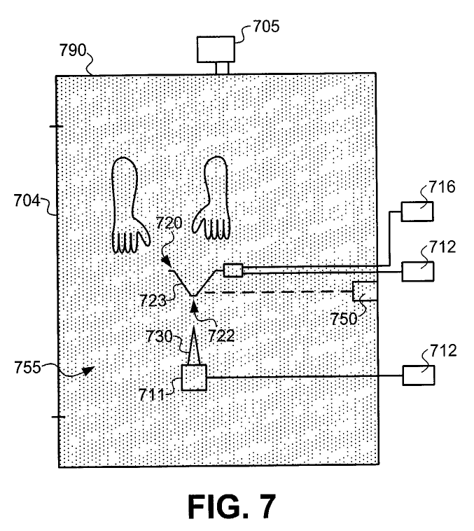

FIG. 7 is a partially schematic illustration of an environmentally controlled container 790 suitable for treating atom probe electrodes 720. In the illustrated embodiment, the container 790 includes a glove box having a fluid control device 705, an emitting device 750, and a sealable passageway 704. The fluid control device 705 (e.g., an ion pump, a vacuum pump, and/or a fluid distribution system) controls the pressure in the container 790 and can introduce various fluids 755 (e.g., liquids or gases, including vapors or plasmas) into the container. The emitting device 750 can include various types of devices including an emitting device 750 that is configured to emit laser energy, radio frequency energy, an electron beam, a molecular beam, and/or an ion beam. The sealable passageway 704 opens to allow items to be placed in and removed from the container 790 and closes or seals to maintain the environmental conditions. In the illustrated embodiment, the passageway 704 is also configured to sealably couple to the first passageway 104a of the atom probe device 100, shown in FIG. 1. Accordingly, the container 790 can be coupled to the atom probe device 100 and items (e.g., treated electrodes) can be transferred while remaining in a controlled environment.

In the illustrated embodiment, an atom probe electrode 720, having a surface and an aperture, is positioned in the container 790 and coupled to an electrical source 712 and a thermal control device 716. In FIG. 7, the container 790 also includes a specimen mount 711 coupled to an electrical source 712. A specimen 730 is carried by the specimen mount 711 and, as discussed below in further detail, can be used to treat the electrode 720. In other embodiments, the container 790 can include more, fewer, and/or other arrangements of components. For example in certain embodiments, the container 790 does not include a specimen mount 711 and/or an emitting device 750. In other embodiments, a getter is used to control (e.g., lower) the pressure in the container 790 instead of the fluid control system 705. In still other embodiments, the electrode 720 is treated in an environmentally controlled or uncontrolled lab and an environmentally controlled container 790 (e.g., a nitrogen dry box) is used to store the electrode 720 and/or transport the electrode 720 to an atom probe device.

As discussed above, in certain embodiments material can be removed from a surface 723 of the electrode 720 to reduce the potential of the electrode 720 creating non-uniformity in an electric field and/or field emission when the electrode 720 is used in an atom probe device during specimen analysis. For example, a chemical polishing process can be used where the electrode 720 is immersed in one or more chemical baths that attack contaminants on the surface 723 of the electrode 720 and/or the bulk material of the electrode 720, smoothing the surface 723 (e.g., removing contaminants and/or protrusions). For example, the fluid 755 in the container 790 can include an acid (e.g., a solution of 30% hydrofluoric acid in nitric acid) and the electrode 720 can be comprised of silicon, nickel, stainless steel, and/or other suitable material(s). The fluid 755 will then attack the bulk material of the electrode 720. In other embodiments, the fluid 755 can include an acid such as hydrofluoric acid and the electrode 720 can be comprised of silicon, nickel, stainless steel, and/or other suitable material(s). The fluid 755 will then attack oxides on the electrode 720.

In other embodiments, removing material from a surface 723 can include an electro-polishing process. For example, the electrode 720 can be immersed in one or more chemical baths. The electrical source 712 coupled to the electrode 720 can apply an electrical current (e.g., an AC or positive DC current) to the electrode 720. The interaction of the electric field created by the voltage and the chemical bath can cause protrusions to be removed from the surface 723. In one embodiment, the fluid 755 can include a 20%-70% orthophosphoric acid in water and the electrode 720 can be comprised of copper. When 1-20 volts are applied to the electrode 720, the surface 723 can be electro-polished or smoothed. In other embodiments, the electro-polishing process can include grounding the electrode 720 and applying an electrical current to the fluid 755 (e.g., an AC or negative DC current).

In still other embodiments, a vapor or plasma etching process can be used to remove material form the surface 723 of the electrode 720. For example, a chemical vapor or plasma-assisted etching process can be used to remove material from the surface 723 with or without an electrical current or radio-frequency (RF) bias applied to the electrode 720 and/or the fluid 755. In one embodiment, the fluid 755 can include a fluorocarbon (e.g., a sulfur hexafluoride (SF₆) vapor), the container 790 can be maintained at a pressure of 0.6-2 mbar, and the resulting reaction can etch away protrusions on electrodes 720 having selected compositions (e.g., electrodes 720 comprised of silicon, nickel, stainless steel, and/or other suitable material(s)). In still other embodiments, the fluid 755 can include a plasma generated by exposing a gas (e.g., oxygen, carbon tetrafluoride, or argon) to an electrical current or RF energy (e.g., via the emitting device 750). The plasma can be used to clean contaminants from the electrode 720 and/or etch protrusions from the electrode 720. Although in the illustrated embodiment, the vapor and plasma etching processes are shown being accomplished in the container 790, many of the vapor or plasma etching processes are also particularly well suited to be accomplished in the atom probe device (e.g., in the load lock or buffer chamber).

In still other embodiments an ion beam milling process can be used to remove material from the surface 723 of the electrode 720. For example, in one embodiment a focused ion beam can be emitted by the emitting device 750 and used to remove small protrusions from the surface 723. Although in the illustrated embodiment, the ion beam milling process is shown being accomplished in the container 790, this process is also particularly well suited to be accomplished in the atom probe device (e.g., in the load lock or buffer chamber). When this process is accomplished in the atom probe device, the fluid control system 105, shown in FIG. 1, can include a turbo molecular pump or an ion pump to evacuate ions from the chamber where the process is performed.

As discussed above, in certain other embodiments material can be deposited on the surface 723 of the electrode 720 to reduce the potential of the electrode 720 creating non-uniformity in an electric field and/or field emission when the electrode 720 is used in an atom probe device during specimen analysis. For example, a thick film deposition process (e.g., electroplating) can be used to deposit material on the surface 723. In certain embodiments, the electrode 720 can be immersed in one or more chemical baths and the electrical source 712 coupled to the electrode 720 can apply a voltage (e.g., a negative AC or DC voltage) to the electrode 720 causing material to be added proximate to and/or over the protrusions on the surface 723, thereby smoothing the surface 723. For example, in one embodiment the fluid 755 can include a solution of 20%-70% sulphuric acid and copper sulphate in water, and 1-20 volts (e.g., negative DC) can be applied to the electrode 720 causing the copper to be deposited on the electrode 720. In other embodiments, a material having a high work function can be deposited on the surface 723 (e.g., platinum can be electroplated to the surface 723). By depositing a material with a high work function, the effective work function of the electrode 720 can be increased. As the effective work function of the electrode is increased, the likelihood of field emission can be reduced.

In other embodiments, a thin film coating process (e.g., a process depositing material at an atomic level) can be used to deposit material onto the surface 723, thereby making the surface 723 smoother. For example, a thin film coating process can include vapor or plasma deposition, chemical vapor deposition, physical vapor deposition, electron beam deposition, and/or molecular beam epitaxy. Additionally, a thin film coating process can be used to deposit a material having a high work function (e.g., tungsten or platinum) onto the surface 723, thereby increasing the effective work function of the electrode 720 and potentially reducing the likelihood of field emission. For example, in one embodiment a self-limiting formation of a thin layer of tungsten on the surface 723 can result when the electrode 720 is comprised of silicon and the fluid 755 is comprised of tungsten hexafluoride (WF₆) maintained in the container 790 at a low pressure.

In still other embodiments, an ion beam assisted deposition process can be used to deposit material onto the surface 723. For example, the fluid 755 can include a vapor comprising platinum or tungsten and the emitting device 750 can be configured to emit an ion beam causing the deposition of platinum or tungsten on the surface 723. Although in the illustrated embodiment, the ion beam assisted deposition process is shown being accomplished in the container 790, this process is also particularly well suited to be accomplished in the atom probe device (e.g., in the load lock or buffer chamber). When this process is accomplished in the atom probe device, the fluid control system 105, shown in FIG. 1, can include an ion pump to evacuate ions from the chamber where the process is performed.

In certain embodiments, at least a portion of the atom probe electrode 720 can be made more robust or stronger (e.g., mechanically or physically stronger) by depositing material on a surface 723 of the atom probe electrode 720. For example, material can be deposited on a surface 723 of the electrode 720 proximate to the aperture of the electrode 720. The added material can strengthen at least the portion of the electrode 720 proximate to the surface 723 (e.g., because of the amount of added material or because of the properties of the added material). This added material can make the electrode more resistant to damage from piece(s) of a specimen that impact the electrode 720 when a specimen fractures during specimen analysis. Additionally, the coating can make the electrode more durable and damage resistant in general (e.g., during transport, storage, and loading into an atom probe device). In one embodiment, a silicon nitride and/or a silicon carbide coating can be deposited (e.g., using a chemical vapor deposition process) on a surface 723 of the electrode 720. The coating can strengthen the portion of the electrode 720 proximate to the surface 723 and/or reduce the potential of the electrode 720 creating non-uniformity in an electric field and/or field emission when the electrode 720 is used in an atom probe device during specimen analysis.

As discussed above, in yet other embodiments the surface 723 of the electrode 720 can be heated and/or cooled to reduce the potential of the electrode 720 creating non-uniformity in an electric field and/or field emission when the electrode 720 is used in an atom probe device during specimen analysis. For example, in certain embodiments the electrode 720 can be annealed to smooth the surface 723 (e.g., by rapidly heating and slowly cooling the surface 723). In one embodiment, the temperature control device 716 can be used to heat the surface 723 above approximately two-thirds of the melting point of a material of the surface 723 (e.g., approximately 500° C. for aluminum) to make the surface 723 smoother. In other embodiments, other temperature control devices 716 can be used, including a radiant heat source. Although in the illustrated embodiment, the annealing process is shown being accomplished in the container 790, this process is also particularly well suited to be accomplished in the atom probe device (e.g., in the load lock or buffer chamber).

In other embodiments a cooling process can be used to reduce the temperature of the electrode 120 (shown in FIG. 1), thereby reducing the level of thermionic emission during specimen analysis. For example, in certain embodiments the temperature control device 116 coupled to the electrode 120, shown in FIG. 1, can cool the surface 123 (FIG. 2) of the electrode 120 to between 5-100 Kelvin, thereby reducing the thermal motion at the atomic level in the surface of the electrode 120. Additionally, cooling the surface 123 can also reduce the potential for field emission. The reduction in thermionic emission and/or the reduction in field emission can increase the accuracy of the analysis process. In other embodiments, cooling the electrode 120 can reduce or slow the migration of contaminants on the probe toward the aperture, which can be caused by the electric field. For example, referring to FIG. 3, in one embodiment the first irregularities 324a can include contaminants and the electric field F can cause the contaminants on the first surface 323a to migrate toward the aperture 322. In certain embodiments, as the contaminants migrate toward or to the aperture, the potential for field emission FE can increase. Cooling the electrode 720 during specimen analysis can reduce or slow this migration.

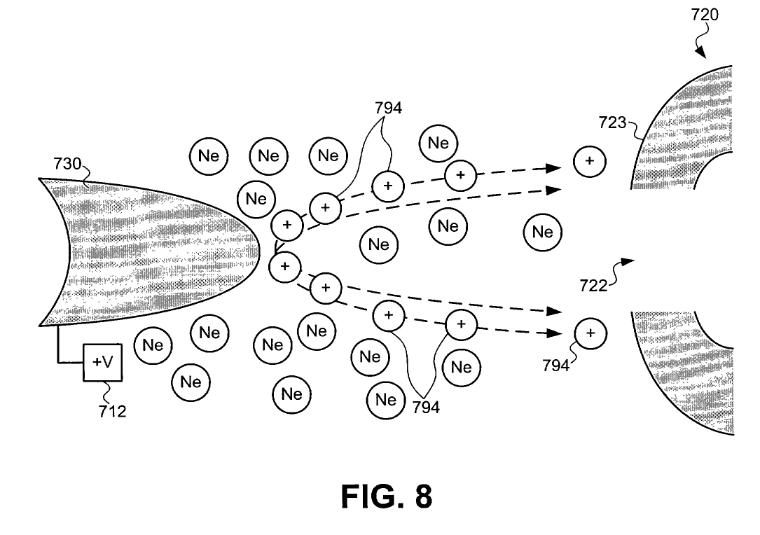

Referring back to FIG. 7, in still other embodiments the surface 723 of the electrode 720 can be impacted with ionized gas atoms (e.g., ionized atoms of neon, helium, argon, hydrogen, oxygen, or carbon monoxide) to reduce the potential of the electrode 720 creating non-uniformity in an electric field and/or field emission when the electrode 720 is used in an atom probe device during specimen analysis. In the illustrated embodiment, the fluid 755 in the container 790 can include neon and the electrical source 712 coupled to the specimen mount 711 can positively charge the specimen 730, ionizing the neon atoms. As shown in FIG. 8, the ionized neon atoms 794 can be propelled toward the electrode 720, which can be grounded or negatively charged. In certain embodiments, the ionized neon atoms 794 can primarily flow to areas on the surface 723 that have low work functions due to the atomic arrangement of the atoms near the surface 723 of the electrode 720. As the ionized neon atoms 794 impact (e.g., peen) the surface 723, the atomic arrangement of the surface 723 can be altered and the work function of the impact area can be increased. Accordingly, the work function across the surface can be made more consistent or uniform, reducing the potential of field emission when the electrode 720 is used in an atom probe during specimen analysis. Although in the illustrated embodiment, the process of impacting the surface 723 with ionized gas atoms is shown being accomplished in the container 790, this process is also particularly well suited to be accomplished in the atom probe device (e.g., in the load lock chamber, buffer chamber, and/or analysis chamber).

Referring again to FIG. 7, in still other embodiments laser energy can be applied to the surface 723 of the electrode 720 to reduce the potential of the electrode 720 creating non-uniformity in an electric field and/or field emission when the electrode 720 is used in an atom probe device during specimen analysis. For example, in the illustrated embodiment the emitting device 750 can be configured to emit laser energy. In one embodiment, the laser energy can be applied to a portion of the surface 723 to reduce disparities and/or inconsistency or non-uniformities in a material of the surface 723 (e.g., peening the portion of the surface 723 to alter the atomic arrangement of the surface material on or near the portion). This peening process can also make the surface 723 smoother and/or stronger. In other embodiments, laser energy can be applied to the surface 723 to heat the surface (e.g., to anneal the surface) making the surface 723 smoother. In still other embodiments, laser energy can be applied to the surface 723 to melt the surface. As the surface cools a smoother surface can be formed. Although in the illustrated embodiment, the process of applying laser energy to the surface 723 is shown being accomplished in the container 790, this process is also particularly well suited to be accomplished in the atom probe device (e.g., in the load lock, buffer chamber, and/or analysis chamber). For example, in certain embodiments the emitting device 150, shown in FIG. 1, can be used to repair or refurbish the electrode 120, while the electrode 120 is installed in the atom probe assembly 110.

As discussed above, aspects of various embodiments described above can be combined. For example, in certain embodiments one or more materials can be deposited on the electrode 720 to facilitate cleaning the electrode 720 after the electrode 720 has been contaminated (e.g., after the electrode has been stored, transported, and/or used to analyze one or more specimen(s)). In certain embodiments, silicon nitride (including all of its stoiciometric combinations), silicon dioxide, molybdenum, and/or platinum can be deposited on the surface 723 of the electrode 720 (e.g., to form a coating or film). After the electrode 720 has collected contaminants, material (e.g., the contaminants) can be removed or cleaned from the electrode 720 using a cleaning process (e.g., a refurbishing process, an acid bath, and/or plasma-etching process). In certain embodiments, the cleaning process “attacks” selected materials, but does not attack or is slow to attack the deposited material. In further embodiments, after removing at least some of the contaminants, additional material can be deposited on the electrode 720 (e.g., the electrode 720 can be re-coated) to facilitate the removal of contaminants in the future and/or to cover contaminants that remain after the cleaning process. In certain embodiments, the original deposited material (e.g., original coating) can be completely removed before new material is deposited on the surface 723. In other embodiments, only a portion of the original deposited material is removed before new material is deposited or none of the originally deposited material is removed.

In still other embodiments, one or more material(s) can be deposited on the surface 723 of the electrode 720 to act as a sacrificial layer during the cleaning process (e.g., a refurbishing process). During the cleaning process, the deposited material comprising the sacrificial layer can be partially or completely removed (e.g., stripped), thereby removing contaminants that have accumulated on portions of the sacrificial layer. For example, in certain embodiments an etching process that selectively removes the deposited material from the material used to fabricate the electrode can be utilized to remove at least a portion of the deposited material, along with contaminants that have accumulated on the deposited material. New material can then be deposited onto the surface 723 of the electrode 720 to act as a new sacrificial layer to facilitate future contaminant removal. For example, in one embodiment an electrode 720 can be comprised of nickel, and silicon dioxide can be deposited on the surface 723 of the electrode 720. After the electrode 720 has collected contaminants, a buffered hydrogen fluoride can be used to strip the silicon dioxide coating from the electrode 720 without removing a significant amount of nickel, thereby removing at least a portion of the contaminants that have collected on the silicon dioxide coating. Another sacrificial layer can then be deposited on the surface 723 of the electrode 720 to facilitate contaminant removal in the future.

A feature of some of the embodiments discussed above is that an atom probe electrode can be treated to reduce a potential of the atom probe electrode creating non-uniformity in an electric field when the atom probe electrode is used in an atom probe device during specimen analysis. By reducing non-uniformities in the electric field, the atom probe device can operate more efficiently, more accurately, and/or with lower field emission. Additionally, the electrode can be treated specifically to reduce a potential of the atom probe electrode creating field emission and/or thermionic emission when the atom probe electrode is used in an atom probe device during specimen analysis. By reducing emissions, the electrode and specimen can be less likely to sustain damage from emitted particles and the atom probe device can operate more efficiently and/or more accurately. Certain processes for reducing non-uniformities and/or reducing the potential for emissions can include making the surface of the electrode smoother and/or increasing a consistency or uniformity of material on the surface of the electrode. Making a surface smoother and/or increasing the consistency or uniformity of material on the surface of the electrode can also increase the consistency or the uniformity of work function over the surface of the electrode. Advantages of these features include better specimen analysis and less atom probe device downtime caused by damaged electrodes and specimens.

Another feature of some of the embodiments discussed above is that electrodes can be refurbished and/or repaired. Because electrodes are difficult and costly to manufacture, an advantage of this feature is that operating costs can be reduced by repairing/refurbishing electrodes versus replacing electrodes. Additionally, many of the treatment processes discussed above can be used to correct production defects in newly manufactured electrodes. An advantage of this feature is that manufacturing costs can be reduced by repairing electrodes with production defects instead of discarding defective electrodes. Additionally, smaller apertures can be formed in the electrodes during the manufacturing process because various treatment processes can be used to correct aperture defects that occur during the production of electrodes with smaller apertures. Smaller apertures can enable the analysis of smaller (e.g., shorter) micro-tip specimens, which are easier to manufacture and can be more densely packed over a given area enabling more regions of interest to be analyzed. Another feature of some of the embodiments discussed above is that electrodes can be repaired/refurbished without removing them from the atom probe device. An advantage of this feature is that atom probe device downtime can be reduced.

Yet another feature of some of the embodiments discussed above is that treatment processes that reduce electric field non-uniformities and emissions can allow electrodes to be positioned closer to specimens during data acquisition. Because the electrode and specimen can be closer to one another, a lower voltage can produce the electric field used to evaporate the specimen. Accordingly, smaller voltage pulses can be used during the evaporation process. Smaller pulse voltages can be generated with faster rise times, and the pulses can be applied more rapidly resulting in improved resolution.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A method for treating an atom probe electrode, comprising:
providing an atom probe electrode having a surface and an aperture; and
removing material from the surface to reduce a potential of the atom probe electrode creating a non-uniformity in an electric field when the atom probe electrode is used in an atom probe device during specimen analysis.

2. The method of claim 1 wherein removing material includes removing material from the surface to reduce a potential of the atom probe electrode creating a field emission when the atom probe electrode is used in an atom probe device during specimen analysis.

3. The method of claim 1 wherein removing material includes:
placing the surface in a fluid; and
reacting the fluid with the surface.

4. The method of claim 1 wherein removing material includes:
placing the surface in a fluid, the fluid including at least one of a liquid and a gas; and
reacting the fluid with the surface.

5. The method of claim 1 wherein removing material includes exposing the surface to a plasma that reacts with the surface.

6. The method of claim 1 wherein removing material includes:
placing the surface in a fluid; and
applying at least one of an electric current and a radio-frequency energy to at least one of the atom probe electrode and the fluid.

7. The method of claim 1 wherein removing material includes removing material from the surface while the atom probe electrode is located in an atom probe device.

8. The method of claim 1 wherein removing material includes removing material from the surface while the atom probe electrode is in a low pressure environment.

9. The method of claim 1 wherein removing material includes removing material from the surface to improve work function uniformity over the surface.

10. The method of claim 1 wherein removing material includes:
placing the surface in at least one of an acid and a fluorocarbon; and
reacting the fluid with the surface.

11. The method of claim 1 wherein removing material includes using an ion beam to remove material from the surface.

12. The method of claim 1 wherein removing material includes removing material to:
(a) make the surface smoother;
(b) increase a consistency of material in the surface; or
(c) both (a) and (b).

13. A method for treating an atom probe electrode, comprising:
providing an atom probe electrode having a surface and an aperture; and
depositing material on the surface to reduce a potential of the atom probe electrode creating a non-uniformity in an electric field when the atom probe electrode is used in an atom probe device during specimen analysis.

14. The method of claim 13 wherein depositing material includes depositing material on the surface to reduce a potential of the atom probe electrode creating a field emission when the atom probe electrode is used in an atom probe device during specimen analysis.

15. The method of claim 13 wherein depositing material includes:
placing the surface in a fluid; and
reacting the fluid with the surface.

16. The method of claim 13 wherein depositing material includes:
placing the surface in a fluid; and
applying at least one of an electric current and a radio-frequency energy to at least one of the atom probe electrode and the fluid.

17. The method of claim 13 wherein depositing material includes depositing material on the surface while the atom probe electrode is located in an atom probe device.

18. The method of claim 13 wherein depositing material includes depositing material on the surface while the atom probe electrode is in a low pressure environment.

19. The method of claim 13 wherein depositing material includes depositing material on the surface to (a) improve work function uniformity over the surface, (b) increase work function effectiveness of the atom probe electrode, or (c) both (a) and (b).

20. The method of claim 13 wherein the surface is comprised of silicon and depositing material includes placing the surface in a low pressure environment with tungsten hexafluoride to coat at least a portion of the surface with tungsten.

21. The method of claim 13 wherein depositing material includes using an ion beam to deposit material onto the surface.

22. The method of claim 13 wherein depositing material includes using at least one of a fluid deposition process, an electron beam deposition process, and a molecular beam deposition process.

23. The method of claim 13 wherein depositing material includes depositing material on the surface to:
(a) make the surface smoother;
(b) increase a consistency of material in the surface; or
(c) both (a) and (b).

24. The method of claim 13 wherein depositing material includes depositing material on the surface to make a portion of the atom probe electrode stronger.

25. A method for treating an atom probe electrode, comprising:
providing an atom probe electrode having a surface and an aperture; and
at least one of heating the surface and cooling the surface to reduce a potential of the atom probe electrode creating a non-uniformity in an electric field when the atom probe electrode is used in an atom probe device during specimen analysis.

26. The method of claim 25 wherein at least one of heating the surface and cooling the surface includes at least one of heating the surface and cooling the surface to reduce a potential of the atom probe electrode creating a field emission when the atom probe electrode is used in an atom probe device during specimen analysis.

27. The method of claim 25 wherein at least one of heating the surface and cooling the surface includes heating the surface to a high temperature to anneal a material of the surface.

28. The method of claim 25 wherein at least one of heating the surface and cooling the surface includes cooling the surface to reduce thermionic emission.

29. The method of claim 25 wherein at least one of heating the surface and cooling the surface includes raising a temperature of the surface above at least approximately two-thirds of the melting point of a material of the surface.

30. The method of claim 25 wherein at least one of heating the surface and cooling the surface includes at least one of heating the surface and cooling the surface while the atom probe electrode is located in an atom probe device.

31. The method of claim 25 wherein at least one of heating the surface and cooling the surface includes at least one of heating the surface and cooling the surface while the atom probe electrode is in a low pressure environment.

32. The method of claim 25 wherein at least one of heating the surface and cooling the surface includes at least one of heating the surface and cooling the surface to improve work function uniformity over the surface.

33. The method of claim 25 wherein at least one of heating the surface and cooling the surface includes at least one of heating the surface and cooling the surface during specimen analysis.

34. The method of claim 25 wherein at least one of heating the surface and cooling the surface includes at least one of heating the surface above 500 degrees Celsius and cooling the surface below 100 Kelvin.

35. The method of claim 25 wherein at least one of heating the surface and cooling the surface includes at least one of heating the surface and cooling the surface to:
(a) make the surface smoother;
(b) increase a consistency of material in the surface; or
(c) both (a) and (b).

36. A method for treating an atom probe electrode, comprising:
positioning an atom probe electrode having a surface and an aperture in an atom probe device; and
cooling the surface of the atom probe electrode during specimen analysis to (a) reduce a potential of thermionic emission, (b) reduce or slow a migration of contaminants towards the aperture, or (c) both (a) and (b).

37. The method of claim 36 wherein cooling the surface includes cooling the surface below 100 Kelvin.

38. A method for treating an atom probe electrode, comprising:
providing an atom probe electrode having a surface and an aperture; and
impacting the surface with ionized gas atoms to reduce a potential of the atom probe electrode creating a non-uniformity in an electric field when the atom probe electrode is used in an atom probe device during specimen analysis.

39. The method of claim 38 wherein impacting a surface includes impacting a surface with ionized gas atoms to alter an atomic arrangement of the atoms proximate to the surface so as to reduce a potential of the atom probe electrode creating a field emission when the atom probe electrode is used in an atom probe device during specimen analysis.

40. The method of claim 38 wherein impacting a surface includes impacting a surface with at least one of ionized neon atoms, ionized helium atoms, ionized argon atoms, ionized hydrogen atoms, ionized oxygen atoms, and ionized carbon monoxide molecules.

41. The method of claim 38 wherein impacting a surface includes impacting a surface with ionized gas atoms produced by applying an electrical charge to a specimen in the atom probe device.

42. The method of claim 38 wherein impacting a surface includes impacting a surface with ionized gas atoms while the atom probe electrode is located in an atom probe device.

43. The method of claim 38 wherein impacting a surface includes impacting a surface with ionized gas atoms while the atom probe electrode is in a low pressure environment.

44. The method of claim 38 wherein impacting a surface includes impacting a surface with ionized gas atoms to improve work function uniformity over the surface.

45. The method of claim 38 wherein impacting a surface includes impacting a surface with ionized gas atoms to:
(a) make the surface smoother;
(b) increase a consistency of material in the surface; or
(c) both (a) and (b).

46. A method for treating an atom probe electrode, comprising:
providing an atom probe electrode having a surface and an aperture; and
applying laser energy to the surface to reduce a potential of the atom probe electrode creating a non-uniformity in an electric field when the atom probe electrode is used in an atom probe device during specimen analysis.

47. The method of claim 46 wherein applying laser energy includes applying laser energy to a surface to reduce a potential of the atom probe electrode creating a field emission when the atom probe electrode is used in an atom probe device during specimen analysis.

48. The method of claim 46 wherein applying laser energy includes applying laser energy to a surface while the atom probe electrode is located in an atom probe device.

49. The method of claim 46 wherein applying laser energy includes applying laser energy to a surface while the atom probe electrode is in a low pressure environment.

50. The method of claim 46 wherein applying laser energy includes applying laser energy to a surface to alter an atomic arrangement of the atoms proximate to the surface.

51. The method of claim 46 wherein applying laser energy includes applying laser energy to a surface to anneal the surface.

52. The method of claim 46 wherein applying laser energy includes applying laser energy to a surface to melt the surface.

53. The method of claim 46 wherein applying laser energy includes applying laser energy to a surface to improve work function uniformity over the surface.

54. The method of claim 46 wherein applying laser energy includes applying laser energy to a surface to:
(a) make the surface smoother;
(b) increase a consistency of material in the surface; or
(c) both (a) and (b).

55. A method for reducing a potential of the atom probe electrode creating a non-uniformity in an electric field when the atom probe electrode is used in an atom probe device during specimen analysis, comprising:
placing the atom probe electrode into an atom probe device, the atom probe electrode having a surface and an aperture; and
treating the atom probe electrode to:
(a) make the surface smoother;
(b) increase a consistency of material in the surface; or
(c) both (a) and (b).

56. The method of claim 55 wherein placing the atom probe electrode includes installing the atom probe electrode into an atom probe assembly of the atom probe device.

57. The method of claim 55 wherein the method further comprises reducing the pressure in at least a portion of the atom probe device where the atom probe electrode is being treated.

58. The method of claim 55 wherein treating the atom probe electrode includes treating the atom probe electrode to improve work function uniformity over a surface.

59. The method of claim 55 wherein treating the atom probe electrode includes treating the atom probe electrode to reduce the potential of an atom probe electrode creating a field emission when the atom probe electrode is used in an atom probe device during specimen analysis.

60. The method of claim 55 wherein treating the atom probe electrode includes at least one of depositing material on the surface, removing material from the surface, heating the surface, cooling the surface, impacting the surface with ionized gas atoms, and applying laser energy to the surface.

61. A method for treating an atom probe electrode, comprising:
providing an atom probe electrode having a surface and an aperture; and
depositing material on the surface of the atom probe electrode, the deposited material being configured to facilitate contaminant removal from the atom probe electrode during a cleaning process.

62. The method of claim 61 wherein depositing material on the surface of the atom probe electrode includes depositing a sacrificial layer on the surface, at least a portion of the sacrificial layer being removable during the cleaning process.

63. The method of claim 61 wherein depositing material on the surface of the atom probe electrode includes depositing at least one of silicon nitride, silicon dioxide, molybdenum, and/or platinum on the surface of the atom probe electrode.

64. The method of claim 61 wherein depositing material on the surface of the atom probe electrode includes depositing a sacrificial layer on the surface, at least a portion of the sacrificial layer being removable during the cleaning process, and wherein the method further comprises performing the cleaning process, the cleaning process removing at least a portion of the sacrificial layer from the surface.

65. A method for treating an atom probe electrode, comprising:
providing an atom probe electrode having a surface and an aperture; and
depositing material on the surface of the atom probe electrode, the deposited material strengthening a portion of the atom probe electrode proximate to the surface.

66. The method of claim 65 wherein depositing material on the surface includes depositing at least one of a silicon nitride material and a silicon carbide material on the surface.
